(19) United States
(12) Patent Application Publication
(10) Pub. No.: US 2020/0354624 A1
(43) Pub. Date: Nov. 12, 2020

(54) Methods For Unconventional Oil Recovery (UOR) By Water-Lipids or Lipids By-Products and Water-Solvent-Lipids or Lipids By-Products Emulsions Flooding

(71) Applicant: APEX ENGINEERING INC., Edmonton (CA)

(72) Inventors: Baki OZUM, Edmonton (CA); Sumanth Kumar ARNIPALLY, Hyderabad (IN); Khosrow NADERI, King of Prussia, PA (US); Nikolas ROMANIUK, Edmonton (CA); Khan Sameem ATHAR, Edmonton (CA)

(21) Appl. No.: 16/871,489

(22) Filed: May 11, 2020

Related U.S. Application Data
(60) Provisional application No. 62/846,242, filed on May 10, 2019.

(51) Int. Cl. C09K 8/584; C09K 8/28; C09K 8/592

(52) U.S. Cl. CPC C09K 8/584; E21B 43/162; C09K 8/592; C09K 8/28

(57) ABSTRACT

A method for improving the increasing the efficiency of an unconventional oil recovery (UOR) process uses biodiesel as a surfactant in water-surfactant emulsions or water-solvent-surfactant emulsions for purposes of water-surfactant emulsions flooding or water-solvent-surfactant emulsions methods. A polymer may be added to the emulsions to increase the emulsion viscosity. Water-surfactant emulsions flooding or water-solvent-surfactant emulsions flooding methods may be implemented in intervals alternating with or sequential to intervals of water-only flooding.

### FIELD

The present disclosure relates in general to methods and processes for improving production efficiency and sweeping efficiency of original oil in place (OOIP) of unconventional oil recovery (UOR) operations, such as cold heavy oil production with sand (CHOPS), Post-CHOPS, and bitumen, heavy oil, and tertiary oil recovery operations.

### BACKGROUND

Canadian Patent No. 2,640,448 and the corresponding U.S. Pat. No. 9,341,051 teach the use of lipids and lipids by-products, such as biodiesel (BD), as additives to increase the efficiency of bitumen and heavy oil recovery processes. As an example of these teachings, BD may be used as surfactant additives to improve the efficiency of steam-assisted bitumen and heavy oil recovery processes. In these applications, liquid BD is injected into the high-temperature, high-pressure steam line at the wellhead.

BD is the commercial name for fatty acids methyl esters, with the chemical formula of CₙHₘCOOCH₃. The hydrocarbon chain is the oil-wet (or hydrophobic) functional group of the BD molecule, having the chemical formula of CₙHₘ, where C and H are the carbon and hydrogen atoms, and n and m are the stoichiometric numbers for C and H atoms with the inequality of m<2n+1 because of a few double bonds between the carbon atoms in the hydrocarbon chain. The methyl ester group, with the chemical formula of COOCH₃ is the water-wet (or hydrophilic) functional group of the BD molecule. Because BD molecules possess both hydrophobic and hydrophilic properties, BD could be used as surfactant additives for several thermal and cold bitumen and oil recovery processes.

All BD species are immiscible with water, with specific gravities less than water, with relatively low viscosity at room temperature (about 20 degrees Celsius), and with boiling points above 300° C. at atmospheric pressure. BD species are chemically stable under high-temperature, high-pressure thermal in-situ bitumen and heavy oil reservoir operating conditions. Furthermore, if hydrolysis reactions take place in the reservoir, hydrolysis products of BD are fatty acids and methanol. Fatty acids also behave as surfactants if the connate water is slightly alkaline (i.e., having a pH >7, with pH being the measure of acidity, defined by the minus logarithm of molar hydrogen ion concentration or −log[H+]). Because of these characteristics, BD, as an example for derivative of fatty acids, could be used as surfactant additives to increase the efficiency of steam-assisted bitumen and heavy oil recovery processes, such as steam-assisted gravity drainage (SAGD), cyclic steam stimulation (CSS), and horizontal cyclic steam stimulation (HCSS) processes.

### BRIEF SUMMARY

The present disclosure teaches embodiments of methods derived from processes described in CA 2,640,448 and U.S. Pat. No. 9,341,051 using BD as surfactant additives to promote the efficiency of SAGD, CSS, and HCSS processes, and in which liquid BD was injected into a high-temperature, high-pressure steam line at the wellhead. In the presently-disclosed methods, however, water-surfactant and water-solvent-surfactant emulsions are prepared and then are used as flooding fluids, with or without polymer additives, at either cold or high temperatures, where “high temperatures” in this context refers to temperatures lower than the boiling points of solvent and water at reservoir operating pressures.

Methods in accordance with the present disclosure improve the efficiency of UOR operations by water-surfactant emulsions flooding and water-solvent-surfactant emulsions flooding methods, where the solvent could be, for example, light hydrocarbons or naphtha (fraction of petroleum refinery products, boiling point under 205° C.). In the presently disclosure, the term “surfactant” is used to refer to lipids and lipids by-products, such as BD. These methods could be implemented at ambient or high (warm) temperatures, with or without polymer addition into water-surfactant and water-solvent-surfactant emulsions. Polymer addition increases the viscosity of water-surfactant and water-solvent-surfactant emulsions; this is a well-known method for increasing the efficiency of UOR processes.

The water-surfactant emulsions flooding method works by:
reducing oil-water interfacial tension, which promotes oil-water attraction, reduces slip velocity at oil-water interphase, and promotes oil permeability, and therefore promotes oil recovery efficiency, as explained by Darcy's Law (which will be familiar to persons skilled in the art); and
reducing oil-water interfacial tension, which promotes oil concentration in water phase by formation of oil-in-water emulsions.

The water-solvent-surfactant emulsions flooding method works by:
reducing oil viscosity by dilution of oil with solvent, which promotes oil mobility, and therefore promotes oil recovery efficiency (as explained by Darcy's Law);
reducing oil-water interfacial tension, which promotes oil-water attraction, reduces slip velocity at oil-water interphase, and promotes oil permeability, and therefore promotes oil recovery efficiency (as explained by Darcy's Law); and
reducing oil-water interfacial tension, which promotes oil concentration in water phase by formation of oil-in-water emulsions.

In both water-surfactant and water-solvent-surfactant flooding applications, when oil droplet sizes in oil-in-water emulsions get larger, the mobility of the emulsion slows down and forces the emulsions used as the flooding fluid to flow through the neighboring pores, which also contributes to improvement of OOIP sweeping efficiency.

Embodiments of methods in accordance with the present disclosure could be implemented at ambient temperature as well as at high (warm) temperatures under the boiling point of water at reservoir operating pressure for water-surfactant emulsions flooding applications, and at temperatures under the boiling points of solvent and water at reservoir operating pressure for water-solvent-surfactant emulsions flooding applications, since the boiling points of lipids and lipids by-products are much higher than the boiling point of water.

Water-surfactant emulsions flooding, with or without polymer addition, implemented either at ambient temperature or at high (warm) temperature, would improve the efficiency of heavy oil production processes such as CHOPS, post-CHOPS, and heavy oil and tertiary oil recovery processes. These methods could be implemented to produce heavy oil (the viscosity of which is typically in the range of about 100 centipoise (cP) to about 500 cP, and may even be as high as about 50,000 cP) by increasing water-surfactant emulsions temperature.

Water-solvent-surfactant emulsions flooding, with or without polymer addition, implemented at ambient temperature could be used for the recovery of higher viscosity heavy oil and tertiary oil. Water-solvent-surfactant emulsions flooding could also be implemented at high (warm) temperatures for recovery of higher-viscosity heavy oil and tertiary oil production, as well as bitumen production from high-permeability or fractured reservoirs.

In such applications, the flooding fluid, which is the water-solvent-surfactant emulsions, could optionally be heated to temperatures under the saturated steam temperature and the boiling point of the solvent under the reservoir operating pressure, since the surfactant is the lipid and lipid by-products, which have much higher boiling points than solvent and water. Commercial implementation of high-temperature (warm) water-solvent-surfactant flooding for high-viscosity heavy oil and bitumen production would eliminate the use of high-temperature, high-pressure steam, and therefore would significantly reduce capital and operating costs for heavy oil and bitumen production.

The present disclosure teaches methods for the use of lipids and lipids by-products, including BD, as surfactant additives to increase the efficiency of UOR processes, such as CHOPS, post-CHOPS, and bitumen, heavy oil, and tertiary oil production, by water-surfactant or water-solvent-surfactant emulsions flooding methods, with or without polymer addition, under cold or high (warm) temperatures. For high-temperature applications, operating temperatures would be under the boiling point of water for water-surfactant emulsions flooding, and under the boiling points of water and solvent for water-solvent-surfactant emulsions flooding, at the reservoir operating pressures.

Water-solvent-surfactant emulsions flooding could be used for the recovery of high viscosity heavy oil and tertiary oil. Water-solvent-surfactant emulsions flooding implemented at higher temperatures could also be used for extra-high-viscosity heavy oil, and bitumen recovery from high-permeability or fractured reservoirs. This method would eliminate the use of high-temperature, high-pressure steam, and therefore would significantly reduce capital and operating costs for heavy oil and bitumen production.

The lipids and lipids by products, including BD, are immiscible with water, and possess surfactant characteristics. Because of these properties, water-surfactant and water-solvent-surfactant emulsions could be used as the flooding fluids injected into the reservoirs to promote oil production efficiency. In these applications, low-molecular-weight hydrocarbons or naphtha (petroleum fraction of boiling temperature under 205° C.) could be used as solvent. Laboratory scale test results have shown that tangible increases in oil production efficiency would be accomplished when surfactant (such as BD) concentration is in the range of about 0.4% to 3% (by mass of emulsion), and solvent concentration is in the range of about 0.5% to about 5% (by mass of emulsion).

Because of the heterogeneous nature of reservoir characteristics, surfactant and solvent concentrations of water-surfactant and water-solvent-surfactant emulsions would be optimized by gaining experience during field trials and commercial operations.

### BRIEF DESCRIPTION OF THE DRAWINGS

Embodiments in accordance with the present disclosure will now be described with reference to the accompanying Figures, in which numerical references denote like parts, and in which:

FIG. 1 is a schematic flow diagram for a prior-art process using biodiesel as a surfactant additive for increasing the efficiency of recovery of bitumen and heavy oil.

FIG. 2A is a photograph from laboratory experiments showing a condensate (hot water) resulting from condensation of a fraction of the steam after injection of biodiesel into a high-temperature, high-pressure steam line.

FIG. 2B is a photograph from laboratory experiments showing a water-BD emulsion resulting from a fraction of the BD injected into a high-temperature, high-pressure steam line condensing with steam.

FIG. 3 is a schematic flow diagram for an embodiment of a process in accordance with the present disclosure, using steam-BD emulsion injection in water-surfactant emulsions flooding applications.

FIG. 4A is an enlarged photograph showing a droplet of process water on a surface of heavy oil.

FIG. 4B is a photograph showing a droplet of process water-BD emulsion on a surface of heavy oil.

### DETAILED DESCRIPTION

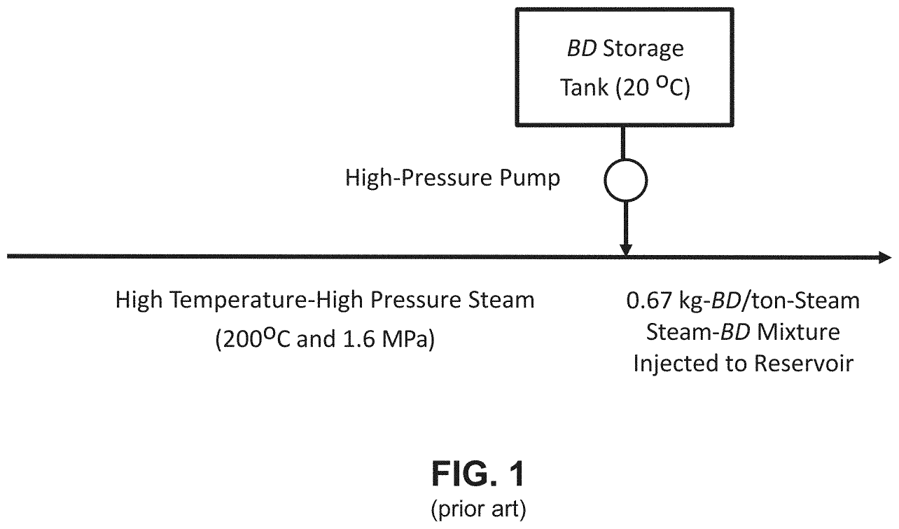

In methods taught by CA 2,640,448 and U.S. Pat. No. 9,341,051, using biodiesel (BD) as surfactant additives in steam-assisted bitumen recovery processes such as SAGD, CSS and HCSS, liquid BD at about 20° C. is injected into a high-temperature (200° C.), high-pressure (1.6 MPa) steam line at the wellhead, just before the steam is injected into the well, as depicted in FIG. 1.

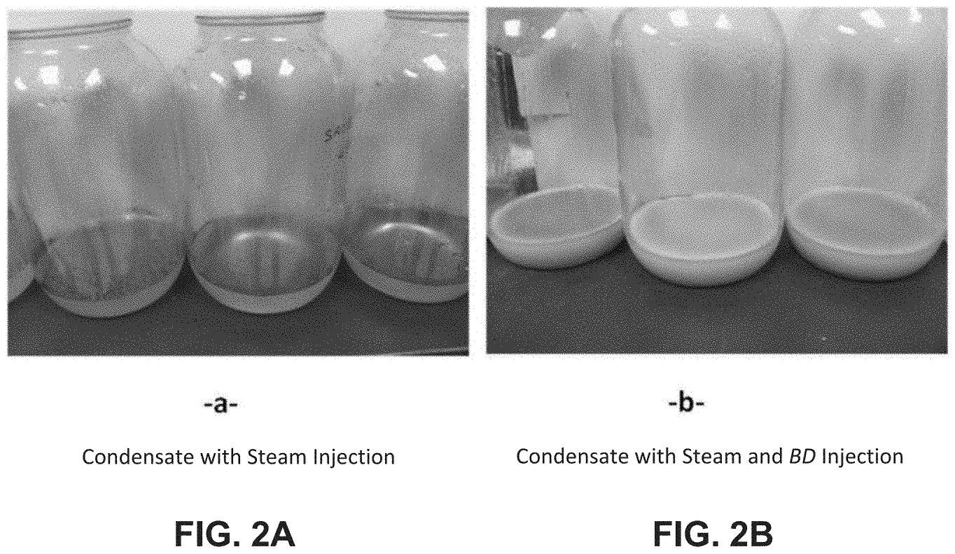

When BD is introduced into the high-temperature, high-pressure steam line, it evaporates in the steam until reaching its saturation concentration. The saturation concentration of BD in steam was calculated by using the vapor pressure versus temperature data of the BD used in laboratory tests. It is calculated that the saturation concentration of BD in high-temperature (for example, 200° C.), high-pressure steam (for example, 1.65 megapascals) is much higher than the required BD dosages in these applications. The required BD dosages, based on experimental test results, are at about 0.667 kilograms of BD per tonne (1,000 kg) of water. When BD is injected into the high-temperature, high-pressure steam line, some fraction of the BD condenses on bitumen in the reservoir before steam condenses into hot water, another fraction of the BD dissolves in bitumen, and the remaining fraction of the BD condenses with steam, forming BD-steam emulsions as depicted in FIGS. 2A and 2B.

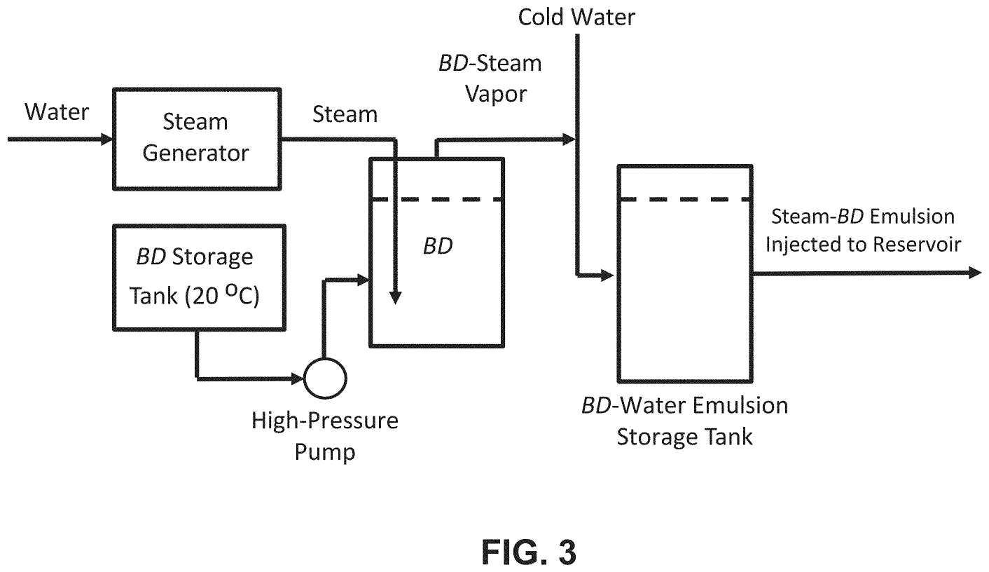

For water-surfactant emulsions flooding applications, the water-surfactant emulsions (e.g., using BD as surfactant) may be prepared (by way of non-limiting example) at a surfactant concentration of about 0.4% to about 3.0% (by mass of the emulsion) by:
dispersing the surfactant (e.g., BD) in water by high-shear mixing, jet-mixing, or any high-shear mechanical mixing methods; or
steam distillation of the surfactant followed by condensing the steam-surfactant vapor in cold water, as depicted in FIG. 3.

The optimum surfactant concentration of the water-surfactant emulsions could be determined as experience is gained in field operations. If polymer addition is also required, the polymer could preferably be added after the water-surfactant emulsions have been prepared.

Water-surfactant emulsions flooding could be used at ambient temperatures or at any temperature lower than the saturated steam temperature under the reservoir operating pressure. For hot water-surfactant emulsions flooding applications, the emulsions must be heated under the reservoir operating pressure, up to any temperature below the saturated steam temperature at the reservoir operating pressure, since almost all lipid and lipid by-products boiling points are much higher than for water.

For flooding applications using water-solvent-surfactant emulsions, the water-solvent surfactant emulsions (e.g., using BD as surfactant) will typically be at a concentration of about 1% to about 5% solvent (such as light hydrocarbons and naphtha) by mass of the emulsion, and at a surfactant concentration of about 0.4% to about 3.0% by mass of the emulsion. The optimum composition of the water-solvent-surfactant emulsions could be determined as experience is gained in field and commercial operations.

Water-solvent-surfactant emulsions for use with methods in accordance with the present disclosure may be prepared (by way of non-limiting example) by:
dispersing the solvent and surfactant (such as BD) in water by high-shear mixing, jet-mixing, or by any high-shear mechanical mixing methods; or
steam distillation of the solvent-surfactant mixture, followed by condensing the steam-solvent-surfactant vapor in cold water, as schematically depicted in FIG. 3.

If polymer addition is necessary or desired, the polymer could be added after preparation of the water-surfactant or water-solvent-surfactant emulsion.

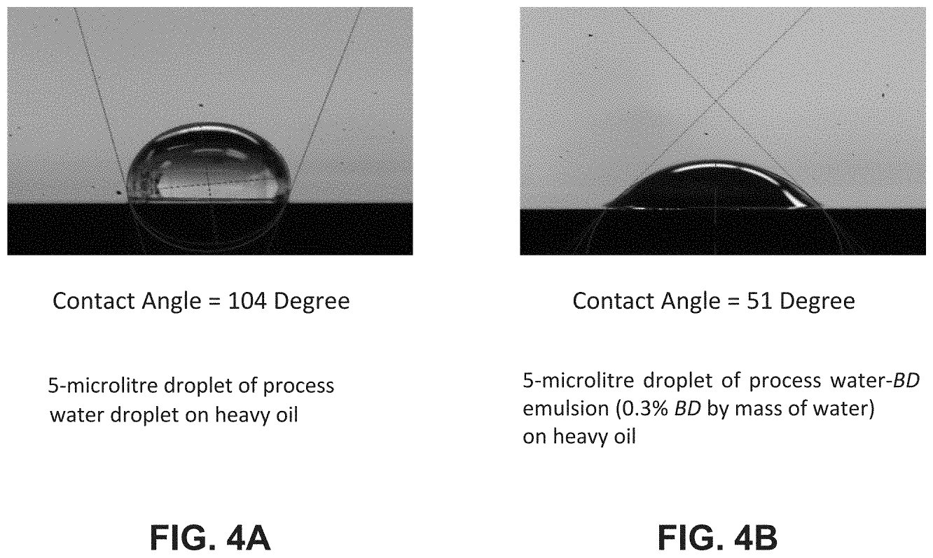

FIG. 4A is an enlarged photograph taken during laboratory tests illustrating a 5-microlitre droplet of process water on a surface of heavy oil, where the process water was recovered from a commercially-produced emulsion of heavy oil and water. As measured during testing, the contact angle for the process water droplet in FIG. 4A (i.e., the angle between the surface of the heavy oil beneath the droplet and a tangent line of the droplet where it contacts the heavy oil surface) was 104 degrees.

FIG. 4B is an enlarged photograph taken during laboratory tests illustrating a 5-microlitre droplet of an emulsion of process water and biodiesel on a surface of heavy oil. As measured during testing, the contact angle for the water-BD emulsion droplet in FIG. 4B was only 51 degrees. This dramatically lower contact angle for the water-BD emulsion droplet, as compared to the contact angle for the process water droplet, clearly demonstrates the effectiveness of BD as a surfactant additive to reduce interfacial tension between bitumen or heavy oil and water, making it readily apparent that the use of BD as surfactant additives will have beneficial effects when implemented in UOR processes.

Water-solvent-surfactant emulsions flooding could be used at ambient temperature or at any temperature below both the saturated steam and solvent boiling points under the reservoir operating pressure. For hot water-solvent-surfactant flooding applications, the emulsions would need to be heated under reservoir operating pressure and up to temperatures below both the saturated steam and solvent boiling points at reservoir operating pressure.

Water-surfactant emulsions flooding or water-solvent-surfactant emulsions flooding may be used during selected time intervals, with the UOR process being continued by water flooding methods only during intervals when no emulsions flooding method is being used. As well, two or more different flooding methods (e.g., water flooding, water-surfactant emulsions flooding, and water-solvent-surfactant emulsions flooding) may be implemented in alternating or sequential stages, with the time interval during which each flooding method is alternatingly or sequentially implemented being in the order of days or weeks, as may be desired or appropriate to suit reservoir characteristics.

It will be readily appreciated by those skilled in the art that various modifications to embodiments in accordance with the present disclosure may be devised without departing from the scope and teaching of the present teachings, including modifications which may use equivalent structures or materials hereafter conceived or developed. It is to be especially understood that the scope of the claims appended hereto should not be limited by any particular embodiments described and illustrated herein, but should be given the broadest interpretation consistent with the description as a whole. It is also to be understood that the substitution of a variant of a claimed element or feature, without any substantial resultant change in functionality, will not constitute a departure from the scope of the disclosure.

In this patent document, any form of the word “comprise” is to be understood in its non-limiting sense to mean that any item following such word is included, but items not specifically mentioned are not excluded. A reference to an element by the indefinite article “a” does not exclude the possibility that more than one such element is present, unless the context clearly requires that there be one and only one such element. Wherever used herein, any form of the word “typical” is to be understood in the sense of representative or common usage or practice, and not as implying invariability or essentiality.

What is claimed is:

1. A method for improving the increasing the efficiency of an unconventional oil recovery (UOR) process, comprising the step of using biodiesel as a surfactant.

2. A method as in claim 1, wherein the UOR process uses water-surfactant emulsions flooding, and wherein the surfactant in the water-surfactant emulsion comprises the biodiesel.

3. A method as in claim 1, wherein the UOR process uses water-solvent-surfactant emulsions flooding, and wherein the surfactant in the water-solvent-surfactant emulsion comprises the biodiesel.

4. A method as in claim 3, wherein the solvent used for the water-solvent-surfactant emulsion comprises light saturated hydrocarbons or naphtha.

5. A method as in claim 2, wherein a polymer is added to the emulsion to increase the viscosity of the emulsion.

6. A method as in claim 2, wherein the water-surfactant emulsions flooding is implemented at approximately ambient temperature or higher, with the temperature of the emulsion being lower than the saturation temperature of steam for water-surfactant emulsion at the reservoir operating pressure, and lower than the saturation temperature of steam and solvent boiling temperature under the reservoir operating pressure.

7. A method as in claim 2, wherein the surfactant concentration of the water-surfactant emulsion is about 0.4% to about 3% (by emulsion mass).

8. A method as in claim 3, wherein the surfactant concentration of the water-solvent-surfactant emulsion is about 0.4% to about 3% (by emulsion mass), and the solvent concentration of the water-solvent-surfactant emulsion is about 1% to about 5% (by emulsion mass).

9. A method as in claim 2, wherein the water-surfactant emulsions flooding is used during selected time intervals, with the UOR process being continued by water flooding methods during intervals when no emulsions flooding method is being used.

10. A method as in claim 9, wherein one or more flooding methods selected from the group consisting of water flooding and water-solvent-surfactant emulsions flooding are implemented in alternating or sequential stages with the water-surfactant emulsions flooding.

11. A method as in claim 3, wherein water-solvent-surfactant emulsions flooding is used during selected time intervals, with the UOR process being continued by water flooding methods during intervals when no emulsions flooding method is being used.

12. A method as in claim 11, wherein one or more flooding methods selected from the group consisting of water flooding and water-surfactant emulsions flooding are implemented in alternating or sequential stages with the water-solvent-surfactant emulsions flooding.
